(19) United States
(12) Patent Application Publication
(10) Pub. No.: US 2021/0330012 A1
(43) Pub. Date: Oct. 28, 2021

(54) METHOD OF AFFIXING AN IMAGE USING A RECEPTOR SUBSTRATE AND STICKER WITHIN AN EMBROIDERED FRAME

(71) Applicant: Cliff R. Rusin, Newport Beach, CA (US)

(72) Inventor: Cliff R. Rusin, Newport Beach, CA (US)

(21) Appl. No.: 17/242,847

(22) Filed: Apr. 28, 2021

Related U.S. Application Data
(60) Provisional application No. 63/016,766, filed on Apr. 28, 2020.

(51) Int. Cl. A41H 27/00; B32B 37/12; B32B 7/09; B32B 7/12; B41J 3/407; A41D 27/08

(52) U.S. Cl. CPC A41H 27/00; B32B 37/12; B32B 7/09; B32B 7/12; B32B 2038/008; A41D 27/08; B32B 2556/00; B32B 2437/00; B41J 3/4075

(57) ABSTRACT

A method of affixing an image to an article of clothing. The method includes providing a patch having a receptor substrate defining a receptor periphery and an embroidered frame sewn along the receptor periphery. The receptor substrate has a receptor side and an opposing attachment side. The method includes providing a sticker having a sticker body with a sticker front side and a sticker back side. The sticker has an image at the sticker front side and sticker adhesive at the sticker back side. The sticker further has a sticker periphery sized and configured to fit within the embroidered frame. The method includes affixing the sticker to the receptor substrate using the sticker adhesive with the sticker back side attached to the receptor side within the embroidered frame. The method includes affixing the patch to the article of clothing with the attachment side against the article of clothing.

### CROSS-REFERENCE TO RELATED APPLICATIONS

This application relates to and claims the benefit of U.S. Provisional Application No. 63/016,766 filed Apr. 28, 2020 and entitled “FRAMED AREA USUALLY BY EMBROIDERY THAT INTERNALLY HAS A RECEPTOR SUBSTRATE TO TAKE A REMOVABLE DECAL” the entire disclosure of which is hereby wholly incorporated by reference.

### STATEMENT RE: FEDERALLY SPONSORED RESEARCH/DEVELOPMENT

Not Applicable

### BACKGROUND

The present disclosure relates generally to patches affixed to an article of clothing. More particularly, the present disclosure relates to patch with a receptor substrate having an embroidered frame and a sticker.

Often an article of clothing includes an image, indicia or branding. This may take the form of silk screening or sublimating the image directly upon the fabric of the article of clothing. This may also take the form of a patch bearing an image being attached to such article of clothing. In any event the article of clothing is dedicated to such associated image.

In view of the foregoing, there is a need in the art for an improved image configuration for use with an article of clothing.

### BRIEF SUMMARY

In accordance with one embodiment, there is provided a method of affixing an image to an article of clothing. The method includes providing a patch. The patch has a receptor substrate defining a receptor periphery and an embroidered frame sewn along the receptor periphery. The receptor substrate has a receptor side and an opposing attachment side. The method further includes providing a sticker having a sticker body with a sticker front side and a sticker back side. The sticker has an image at the sticker front side and sticker adhesive at the sticker back side. The sticker further has a sticker periphery sized and configured to fit within the embroidered frame. The method further includes affixing the sticker to the receptor substrate using the sticker adhesive with the sticker back side attached to the receptor side within the embroidered frame. The method further includes affixing the patch to the article of clothing with the attachment side against the article of clothing.

According to various embodiments, the receptor substrate may be formed of a sheet of plastic material. The attachment side of the substrate may have patch adhesive distributed across the attachment side, and the affixing of the patch may include using the patch adhesive to affix the patch to the article of clothing. The patch adhesive may be a heat activated adhesive. The affixing of the patch may include sewing the embroidered periphery to the article of clothing. The receptor substrate has intersecting grooves formed in the receptor side. The providing of the sticker may include providing a sticker sheet having an image side and an opposing adhesive side, and printing a plurality of images upon the image side of the sticker sheet using a computer printer. The sticker sheet may have a plurality of perforated sticker boundaries. The pluralities of images are respectively printed within the plurality of perforated sticker boundaries. The providing of the sticker may further include selecting a specific one of the pluralities of perforated sticker boundaries and removing a portion of the sticker sheet within the selected one of the plurality of perforated sticker boundaries to form the sticker.

According to another embodiment, there is provided a method of affixing an image to an article of clothing. The method includes providing a patch, the patch having a receptor substrate defining a receptor periphery and an embroidered frame sewn along the receptor periphery. The receptor substrate has a receptor side and an opposing attachment side. The method further includes providing a sticker sheet having an image side and an opposing adhesive side. The method further includes printing a plurality of images upon the image side of the sticker sheet using a computer printer, the sticker sheet having a plurality of perforated sticker boundaries. The pluralities of images are respectively printed within the plurality of perforated sticker boundaries. The method further includes selecting a specific one of the pluralities of perforated sticker boundaries. The method further includes removing a portion of the sticker sheet within the selected one of the plurality of perforated sticker boundaries to form a sticker. The sticker has a sticker body with a sticker front side and a sticker back side, The sticker has an image of the printed plurality of images at the sticker front side and sticker adhesive at the sticker back side. The sticker further has a sticker periphery sized and configured to fit within the embroidered frame. The method further includes affixing the sticker to the receptor substrate using the sticker adhesive with the sticker back side attached to the receptor side within the embroidered frame. The method further includes affixing the patch to the article of clothing with the attachment side against the article of clothing. The receptor substrate may be formed of a sheet of plastic material. The attachment side of the substrate may have patch adhesive distributed across the attachment side, and the affixing of the patch includes using the patch adhesive to affix the patch to the article of clothing. The patch adhesive may be a heat activated adhesive. The affixing of the patch may include sewing the embroidered periphery to the article of clothing. The receptor substrate may have intersecting grooves formed in the receptor side.

According to another embodiment, there is provided an image patch for affixing to an article of clothing. The image patch includes a patch and a sticker. The patch has a receptor substrate defining a receptor periphery and an embroidered frame sewn along the receptor periphery. The receptor substrate has a receptor side and an opposing attachment side. The receptor substrate has intersecting grooves formed in the receptor side. The sticker has a sticker body with a sticker front side and a sticker back side. The sticker has an image at the sticker front side and sticker adhesive at the sticker back side. The sticker further has a sticker periphery sized and configured to fit within the embroidered frame. The sticker back side is attached to the attachment side and covering the intersecting grooves. The receptor substrate may be formed of a plastic material.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a front view of an image patch according to an embodiment of the invention;

FIG. 2 is an exploded view of the image patch of FIG. 1 with a patch and a sticker;

FIG. 3 is a cross-sectional view of the sticker along axis 3-3 of FIG. 2;

FIG. 4 is a perspective view of the image patch affixed to a portion of a hat;

FIG. 5 is a perspective view of another image patch affixed to a portion of a shirt;

FIG. 6 is a symbolic view of a computer with a computer printer in the process of printing a sticker sheet having a plurality of stickers;

FIG. 7 is a front view of a printed sticker sheet with a plurality of stickers each with an image;

FIG. 8 is a front view of an unprinted sticker sheet;

FIG. 9 is a front view of a printed sticker sheet of FIG. 8 with a plurality of stickers after having been printed upon to form the plurality of printed stickers each with a printed image;

FIG. 10 is a front view of the printed sticker sheet of FIG. 9 with some of the printed stickers having been removed;

FIG. 11 is a front view of a receptor substrate sheet;

FIG. 12 is a front view of the receptor substrate sheet of FIG. 11 a plurality of embroidered frames;

FIG. 13 is a front view of the receptor substrate sheet of FIG. 12 with one of the embroidered frames and encircled receptor substrate having been removed;

FIG. 14 is an enlarged view of a selected one of the substrate sheet sections and the surrounding portion of the receptor substrate sheet of FIG. 12;

FIG. 15 is an enlarged view of a portion of the substrate sheet section and the surrounding portion of the receptor substrate sheet of FIG. 14;

FIG. 16 is a cross-sectional view of the substrate sheet section and the surrounding portion of the receptor substrate sheet along axis 16-16 of FIG. 14; and

FIG. 17 is a cross-sectional view of the substrate sheet section and the surrounding portion of the receptor substrate sheet along axis 17-17 of FIG. 15.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as top and bottom, first and second, and the like are used solely to distinguish one entity from another without necessarily requiring or implying any actual such relationship or order between such entities.

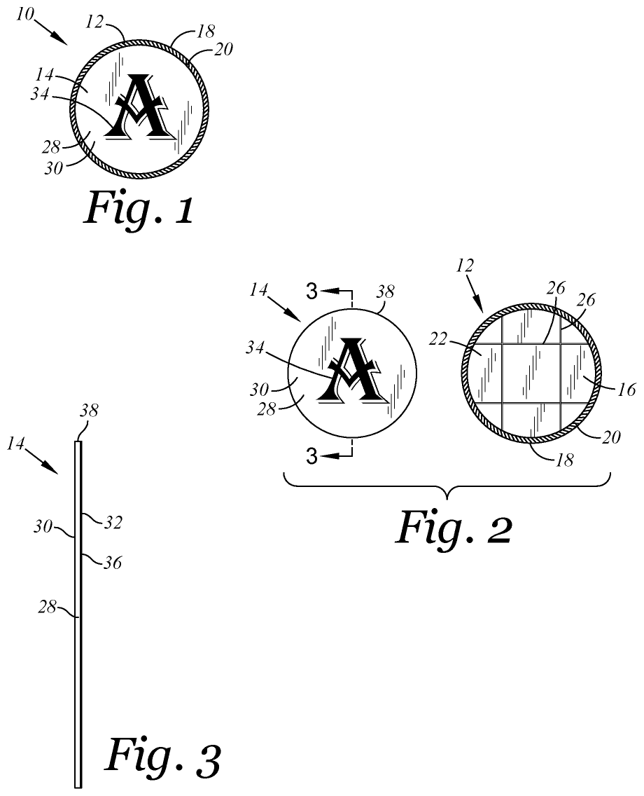

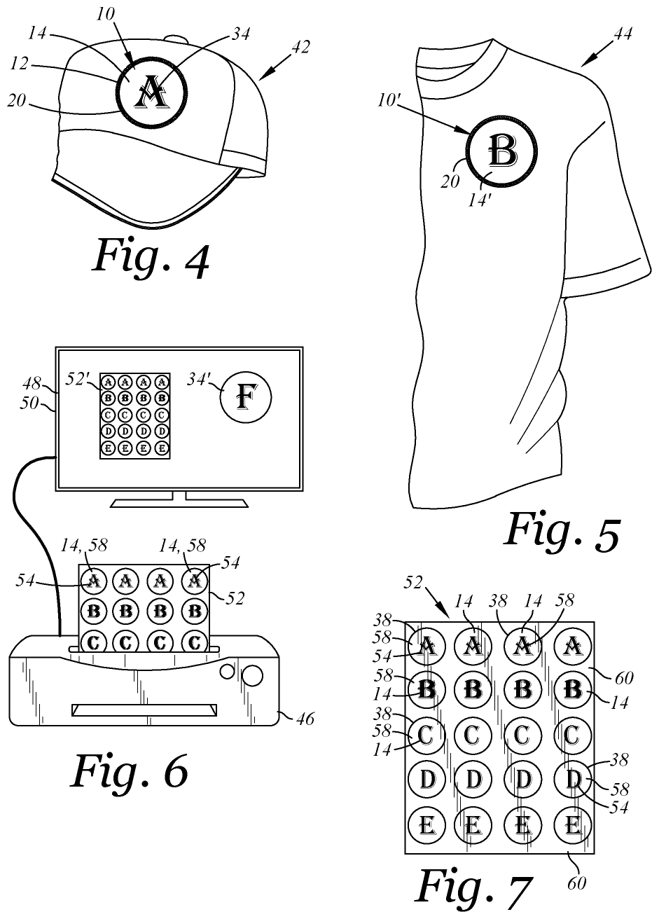

Referring now to FIG. 1 there is depicted a front view of an image patch 10 according to an embodiment of the invention. FIG. 2 is an exploded view of the image patch 10 of FIG. 1 with a patch 12 and a sticker 14. FIG. 3 is a cross-sectional view of the sticker 14 along axis 3-3 of FIG. 2. FIG. 4 is a perspective view of the image patch 10 affixed to a portion of a hat 42. FIG. 5 is a perspective view of another image patch 10′ affixed to a portion of a shirt 44.

According to an embodiment, there is provided the image patch 10 for affixing to an article of clothing, such as the hat 42 or the shirt 44. The image patch 10 includes the patch 12 and the sticker 14. The patch 12 has a receptor substrate 16 defining a receptor periphery 18 and an embroidered frame 20 sewn along the receptor periphery 18. The receptor substrate 16 has a receptor side 22 and an opposing attachment side 24. The receptor substrate 16 has intersecting grooves 26 formed in the receptor side 22. The sticker 14 has a sticker body 28 with a sticker front side 30 and a sticker back side 32. The sticker 14 has an image 34 at the sticker front side 30 and sticker adhesive 36 at the sticker back side 32. In the example depicted, the image 34 is of the letter “A.” The sticker 14 further has a sticker periphery 38 sized and configured to fit within the embroidered frame 20. The sticker back side 32 is attached to the attachment side 34 and covering the intersecting grooves 26.

The receptor substrate 16 may be formed of a plastic material, such as a sheet of thin vinyl. In this respect the receptor substrate 16 may be soft enough to be sewn through to enable the embroidered frame 20 to be formed and yet structurally sufficient so as to support the threads of the embroidered frame 20. Further, the receptor substrate 16 may be pliable so as to conform to curvatures and flexing of the article of clothing to which the image patch 10 may be attached. Other materials may be used, such as formed of cloth.

As mentioned above, the intersecting grooves 26 may extend across the receptor substrate 16. The intersecting grooves 26 may extend beyond the sticker periphery 38 with the sticker back side 32 attached to the receptor side 22. In general, the use of a sticker 14 being applied to a smooth surface, especially a surface which may be flexible, has the potential to have air bubbles trapped by sticker adhesive 36. This would result in the sticker 14 not being fully and attached to the intended surface and include unsightly bubbled regions, or worse, an overlapping section of sticker 14 (i.e., a wrinkled section). However, as the receptor substrate 16 includes the intersecting grooves 26, this allows for a pathway for any trapped air bubbles to be escape from being adhesively affixed at the receptor side 22. The sticker 14 may be pressed and pushed at localized portions of the sticker front side 30 so as to manipulate any air bubbles towards the sticker periphery 38 until such air bubbles are removed.

As is depicted, the receptor substrate 16 has two horizontal and two vertical intersecting grooves 26. It is contemplated that the intersecting grooves 26 may be of various other configurations than as shown, such as fewer or more in number, differing angles, and differing cross-sectional proportion and sizing. The widths of the intersecting grooves 26 may be sized small enough such that when the sticker 14 is applied to the receptor substrate 16 the geometry or outline of the intersecting grooves 26 does not result in the sticker 14 having angles or localized curves or depressions associated with the intersecting grooves 26. As such, the sticker 14 may have a generally smooth surface conforming to the overall surface configuration of the receptor substrate 16.

It is contemplated that the forgoing described image patch 10 may be utilized by selectively timing when the image 10 is affixed to the receptor substrate 16. By controlling such timing, a manufacturer, seller or retailer of articles of clothing may readily control the inventory of various specific ones of branded clothing by choosing which images 34 are to be affixed to the patch 12. At the end consumer level, the image 34 of the sticker 14 or sticker 14 already having an image 34 may be selected at will and affixed stickers 14 are contemplated to be able to be removed and replaced with differing images 34. This allows for a high degree of personalization customization with a single article of clothing. It is contemplated that packs of stickers 14 with differing images 34 may be provided to allow an end consumer to change at will the images 34 affixed to an article of clothing.

Next will be discussed exemplary methods of making the image patch 10. Referring now to FIG. 6 there is depicted a symbolic view of a computer 48 and a display 50 connected to a computer printer 46. The computer printer 46 is depicted as being in the process of printing a sticker sheet 52 having a plurality of stickers 14. As is depicted on the display 50, there is a sticker sheet representation 52′ with various images and a selected image 34′ is enlarged. The sticker sheet 52 has a plurality of images 54 printed on the sticker sheet 52 in various sticker sheet sections 58 within a respective sticker periphery 38. FIG. 7 is a front view of the printed sticker sheet 52. It is contemplated that an end consumer may be provided access to computer software to facilitate the printing of desired images on the sticker sheet 52. This allows for a do-it-yourself (DIY) approach to not just sticker design but the design of one's own image patch 10. Further, the stickers 14 may be removed from the patch 12 and to allow the end consumer to change out different images to customize the associated item of apparel at will.

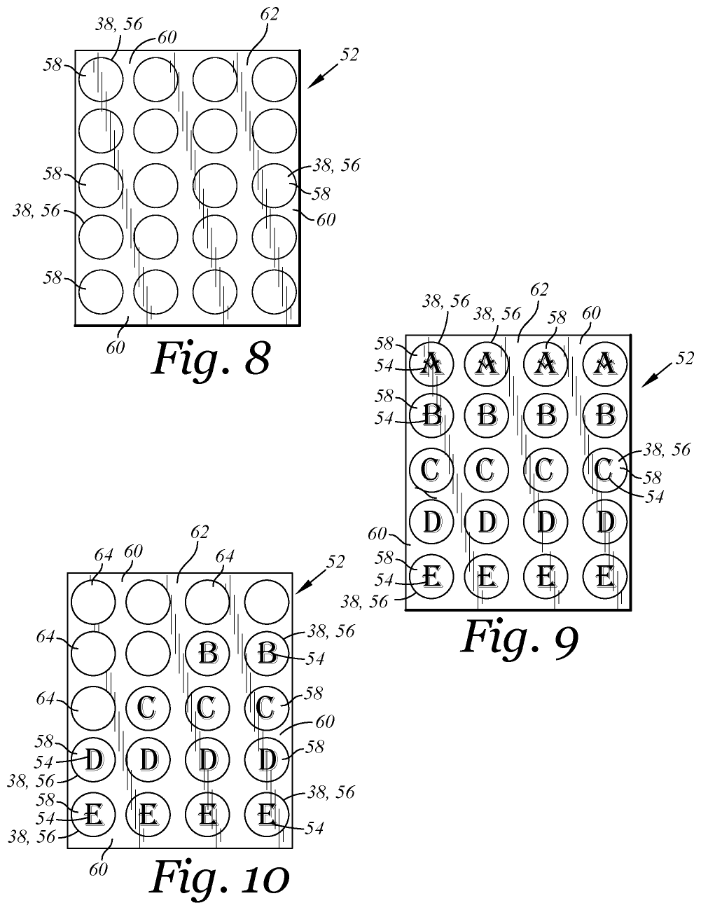

Referring now to FIG. 8 there is depicted a front view of an unprinted sticker sheet 52. The sticker sheet 52 incudes a plurality of sticker sheet sections 58 each bounded by a plurality of perforated sticker boundaries 56. The sticker sheet includes a sticker layer 62 that includes the various sticker sheet sections 58 and sticker sheet excess 60 that is disposed between and surrounds the sticker sheet sections 58. The perforated sticker sheet boundaries 56 may be perforated or otherwise cut, such as via a kiss cut operation. This enables the sticker sheet sections 58 to be readily removed from the surrounding sticker sheet excess 60. However, it is understood that such perforations or cuts are not required. As discussed above, all that is required is that the sticker periphery 38 of the end product sticker 14 be sized so as to fit within the embroidered frame 20. In this respect the sticker sheet sections 58 may be cut at some later time after printing operations.

Referring now to FIG. 9 there is depicted the front view of the sticker sheet 52 of FIG. 8 with a plurality of stickers 14 after having been printed upon to form the plurality of printed stickers 14 each with a printed image 54. FIG. 10 is a front view of the printed sticker sheet 52 of FIG. 9 with some of the printed stickers 14 having been removed. The sticker sheet 52 includes a topmost layer in the form of the sticker sheet sections 58 and the surrounding sticker sheet excess 60. The backing of such layer may include the sticker adhesive 36. In this regard, a release layer 64 may be disposed behind the sticker layer 62 and the surrounding sticker sheet excess 60. The release layer 64 may include a wax or wax-like coating upon a paper sheet. This allows the sticker adhesive 36 to be readily released from such coating.

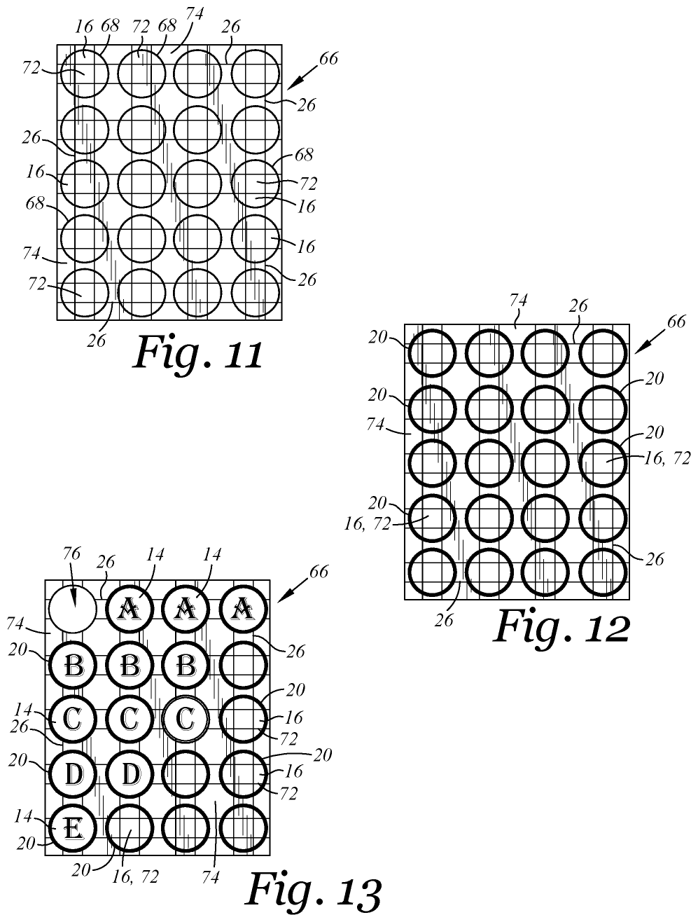

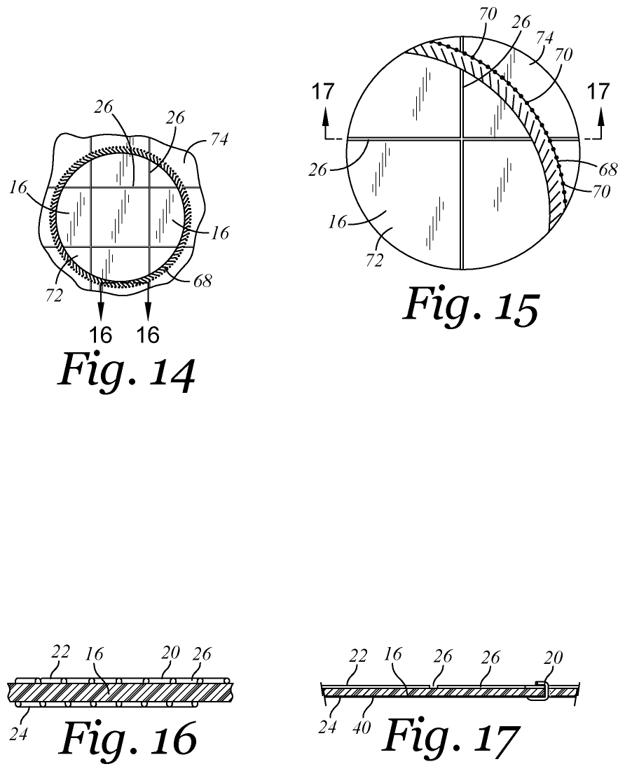

Referring now FIG. 11 there is depicted a front view of the receptor substrate sheet 66. The receptor substrate sheet 66 includes the receptor substrate 16 with the intersecting grooves 26 formed in the receptor substrate 16. The receptor substrate sheet 66 includes a plurality of perforated substrate boundaries 68 that surround corresponding the substrate sheet sections 72. The receptor substrate sheet 66 includes the substrate sheet sections 72 and substrate sheet excess 74 that is disposed between and surround the substrate sheet sections 72. The perforated substrate boundaries 68 are formed by a plurality of perforations 70 (as seen the in enlarged view of FIG. 15 discussed further below). The configuration of the perforated substrate boundaries 68 correspond to the desired shape and sizing of the corresponding end product image patch 10.

Referring now to FIG. 12, in manufacturing the patch 12, the embroidered frame 20 is attached to the receptor substrate 16. In an embodiment, this may be done by sewing the receptor substrate 16 to form the embroidered frame 20. In manufacturing a plural of patches 12, the receptor substrate sheet 66 may be sewn to form a plurality of embroidered frames 20 just within each of the perforated substrate boundaries 68. In the embodiment depicted, the embroidered frame 20 is a repetitively sewn series of sequential loops of thread. In another embodiment, it is contemplated that the embroidered frames 20 may be formed by proving a length of rope or braided strands that are attached to the receptor substrate sheet 66, such as by gluing the length to the receptor substrate sheet 66. The affixed length corresponds to the distance of the embroidered frame 20.

Referring now to FIG. 13 there is depicted a front view of the receptor substrate sheet 66 of FIG. 12 with one of the embroidered frames 20 (at the upper left corner) and encircled receptor substrate 16 having been removed to create a void 76. It is contemplated that such void 76 is created by tearing out the corresponding receptor substrate 16 along the perforated substrate boundary 68 away from the surrounding substrate sheet excess 74. As is depicted, various stickers 14 are attached to the receptor substrate sheet 66 within respective embroidered frames 20 and it is recognized that a patch 12 may be formed by removing such stickers 14 and the associated substrate sheet section 72 from the surrounding substrate sheet excess 74.

FIG. 14 is an enlarged view of a selected one of the substrate sheet sections 72 and the surrounding portion of the substrate sheet excess 74 of FIG. 12. FIG. 15 is an enlarged view of a portion of the substrate sheet section 72 surrounding portion of the substrate sheet excess 74 of FIG. 14. In this enlarged view, the perforated substrate boundary 68 is depicted as being formed by a series of perforations 70. The sizing, number and shape of the perforations may vary. The perforations 70 are intended to structurally weaken the receptor substrate sheet 66 at such locations so as to allow for the encircled substrate sheet section 72 to be readily torn out of the receptor substrate sheet 66. FIG. 16 is a cross-sectional view of the substrate sheet section 72 along axis 16-16 of FIG. 14. FIG. 17 is a cross-sectional view of the substrate sheet section 72 and the surrounding portion of the receptor substrate 16 along axis 17-17 of FIG. 15.

As used herein the term sticker 14 refer to a sheet like layer, decal or film which may be attached to the receptor substrate 16 through the use of an adhesive (such as the sticker adhesive 36 that is attached the sticker back side 32) and upon which the image 34 may be disposed. Further, the sticker adhesive may be applied to the receptor substrate 16 rather than first directly to the sticker back side 32.

As used herein the term patch 12 refers generally to a piece of material that includes the receptor substrate 16 and bounded by the embroidered frame 20 that may be attached or affixed to an article of clothing.

It is contemplated that the image patch 10 may be attached to an article of clothing, such as the cap 42. In an embodiment, image patch 10 is attached to the article of clothing by the use of patch adhesive 40 that this provided at the attachment side 24 of the receptor substrate 16. Such patch adhesive 40 may be heat activated and as such the image patch 10 may be of an iron-on type of patch. In another embodiment, the image patch 10 may be attached to an article of clothing by being sewn on. In such an embodiment, the embroidered frame 20 would be sewn though to the fabric of the article of clothing.

The various components of the image patch 10, may have various shapes, surface textures and sizes and formed of various materials which are chosen from those which are well known to one of ordinary skill in the art. Further, the various components of the image patch 10 may be manufactured and assembled according to those techniques which are chosen from those which are well known to one of ordinary skill in the art.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method of affixing an image to an article of clothing, the method comprising:
providing a patch, the patch having a receptor substrate defining a receptor periphery and an embroidered frame sewn along the receptor periphery, the receptor substrate having a receptor side and an opposing attachment side;
providing a sticker having a sticker body with a sticker front side and a sticker back side, the sticker having an image at the sticker front side and sticker adhesive at the sticker back side, the sticker further having a sticker periphery sized and configured to fit within the embroidered frame;
affixing the sticker to the receptor substrate using the sticker adhesive with the sticker back side attached to the receptor side within the embroidered frame; and
affixing the patch to the article of clothing with the attachment side against the article of clothing.

2. The method of claim 1 wherein the receptor substrate is formed of a sheet of plastic material.

3. The method of claim 1 wherein the attachment side of the substrate has patch adhesive distributed across the attachment side, the affixing of the patch includes using the patch adhesive to affix the patch to the article of clothing.

4. The method of claim 3 wherein the patch adhesive is a heat activated adhesive.

5. The method of claim 1 wherein the affixing of the patch includes sewing the embroidered periphery to the article of clothing.

6. The method of claim 1 wherein the receptor substrate has intersecting grooves formed in the receptor side.

7. The method of claim 1 wherein the providing of the sticker includes:
providing a sticker sheet having an image side and an opposing adhesive side; and
printing a plurality of images upon the image side of the sticker sheet using a computer printer, the sticker sheet having a plurality of perforated sticker boundaries, the pluralities of images are respectively printed within the plurality of perforated sticker boundaries.

8. The method of claim 7 wherein the providing of the sticker further includes:
selecting a specific one of the pluralities of perforated sticker boundaries; and
removing a portion of the sticker sheet within the selected one of the plurality of perforated sticker boundaries to form the sticker.

9. A method of affixing an image to an article of clothing, the method comprising:
providing a patch, the patch having a receptor substrate defining a receptor periphery and an embroidered frame sewn along the receptor periphery, the receptor substrate having a receptor side and an opposing attachment side;
providing a sticker sheet having an image side and an opposing adhesive side;
printing a plurality of images upon the image side of the sticker sheet using a computer printer, the sticker sheet having a plurality of perforated sticker boundaries, the pluralities of images are respectively printed within the plurality of perforated sticker boundaries;
selecting a specific one of the pluralities of perforated sticker boundaries;
removing a portion of the sticker sheet within the selected one of the plurality of perforated sticker boundaries to form a sticker, the sticker having a sticker body with a sticker front side and a sticker back side, the sticker having an image of the printed plurality of images at the sticker front side and sticker adhesive at the sticker back side, the sticker further having a sticker periphery sized and configured to fit within the embroidered frame;
affixing the sticker to the receptor substrate using the sticker adhesive with the sticker back side attached to the receptor side within the embroidered frame; and
affixing the patch to the article of clothing with the attachment side against the article of clothing.

10. The method of claim 9 wherein the receptor substrate is formed of a sheet of plastic material.

11. The method of claim 9 wherein the attachment side of the substrate has patch adhesive distributed across the attachment side, the affixing of the patch includes using the patch adhesive to affix the patch to the article of clothing.

12. The method of claim 11 wherein the patch adhesive is a heat activated adhesive.

13. The method of claim 9 wherein the affixing of the patch includes sewing the embroidered periphery to the article of clothing.

14. The method of claim 9 wherein the receptor substrate has intersecting grooves formed in the receptor side.

15. An image patch for affixing to an article of clothing, the ASDF comprising:
a patch having a receptor substrate defining a receptor periphery and an embroidered frame sewn along the receptor periphery, the receptor substrate having a receptor side and an opposing attachment side, the receptor substrate having intersecting grooves formed in the receptor side; and
a sticker having a sticker body with a sticker front side and a sticker back side, the sticker having an image at the sticker front side and sticker adhesive at the sticker back side, the sticker further having a sticker periphery sized and configured to fit within the embroidered frame, the sticker back side being attached to the attachment side and covering the intersecting grooves.

16. The image patch of claim 15 wherein the receptor substrate is formed of a plastic material.
